(19) United States
(12) Patent Application Publication
(10) Pub. No.: US 2008/0236420 A1
(43) Pub. Date: Oct. 2, 2008

(54) Liquid transfer method and liquid transfer apparatus

(75) Inventors: Reiji Ito, Ibaraki (JP); Akihiro Matsukawa, Ibaraki (JP); Yoshihito Nakamura, Ibaraki (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Komori Corporation

(21) Appl. No.: 12/079,571

(22) Filed: Mar. 26, 2008

(30) Foreign Application Priority Data
Mar. 27, 2007 (JP) 081309/2007

(51) Int. Cl. B41F 7/02

(52) U.S. Cl. 101/217; 101/492

(57) ABSTRACT

A liquid transfer method includes the steps of conveying a sheet by holding the sheet by a transport cylinder, and transferring a liquid to one surface of the sheet by a transfer cylinder opposing the transport cylinder and transferring the liquid to the other surface of the sheet by the transport cylinder. The step of transferring includes the step of positioning an edge of a region on one surface of the sheet, downstream in a sheet convey direction, where the liquid is to be transferred, upstream in the sheet convey direction of an edge of a region on the other surface of the sheet, downstream in the sheet convey direction, where the liquid is to be transferred. A liquid transfer apparatus is also disclosed.

### BACKGROUND OF THE INVENTION

The present invention relates to a liquid transfer method and liquid transfer apparatus which transfer a liquid such as varnish or ink to the two surfaces of a sheet.

As a conventional liquid transfer apparatus, one disclosed in Japanese Patent Laid-Open No. 2003-182031 is available. This liquid transfer apparatus comprises a first blanket cylinder (transport cylinder) which holds and conveys a sheet by gripping its one edge, and a second blanket cylinder which opposes the first blanket cylinder. As the sheet passes between the first and second blanket cylinders, varnish is transferred from the second blanket cylinder to the obverse of the sheet, thus coating the obverse of the sheet. Simultaneously, the printing pressure of the second blanket cylinder transfers the varnish from the first blanket cylinder to the reverse of the sheet, thus coating the reverse of the sheet as well.

In the conventional apparatus described above which transfers the liquid to the sheet, when performing overall coating on the two surfaces of the sheet, the following problem occurs. Note that overall coating refers to coating of the sheet entirely excluding margins reserved on the leading, trailing, left, and right edges of the sheet. When overall coating is to be performed on a sheet printed with ink, overall coating refers to coating that completely covers the images and register marks printed with the ink.

When performing overall coating on the two surfaces of the sheet, immediately after the leading edge of the sheet passes between the first and second blanket cylinders, the leading edge of the obverse of the sheet undesirably adheres to the second blanket cylinder due to the tackiness of the varnish on the obverse of the sheet, so that the leading edge of the reverse of the sheet is sometimes pulled to be separate from the surface of the first blanket cylinder. Then, transfer nonuniformities occur in the varnish transferred from the first blanket cylinder to the reverse of the sheet to degrade the coating quality. This problem also arises in a printing apparatus which prints using high-viscosity ink.

### SUMMARY OF THE INVENTION

The present invention has been made to solve this problem and has as its object to prevent the sheet from separating from the transport cylinder, thus improving the transfer quality.

In order to achieve the above object, according to an aspect of the present invention, there is provided a liquid transfer method comprising the steps of conveying a sheet by holding the sheet by a transport cylinder and transferring a liquid to one surface of the sheet by a transfer cylinder opposing the transport cylinder, and transferring the liquid to the other surface of the sheet by the transport cylinder, wherein the step of transferring comprises the step of positioning an edge of a region on one surface of the sheet, downstream in a sheet convey direction, where the liquid is to be transferred, upstream in the sheet convey direction of an edge of a region on the other surface of the sheet, downstream in the sheet convey direction, where the liquid is to be transferred.

According to another aspect of the present invention, there is also provided a liquid transfer apparatus comprising a first transfer cylinder which transfers a liquid to one surface of a sheet, and a transport cylinder which opposes the first transfer cylinder, holds and conveys the sheet, and transfers the liquid to the other surface of the sheet, wherein the first transfer cylinder and the transport cylinder transfer the liquid such that an edge of a region on one surface of the sheet, downstream in a sheet convey direction, where the liquid is to be transferred is located upstream in the sheet convey direction of an edge of a region on the other surface of the sheet, downstream in the sheet convey direction, where the liquid is to be transferred.

### BRIEF DESCRIPTION OF THE DRAWINGS

FIG. 1 is a side view of a coating unit in a printing press according to one embodiment of the present invention;

FIG. 2 is a side view of each of first and second phase adjustment devices;

FIG. 3 is a view seen from the line of an arrow III in FIG. 2;

FIG. 4 is a side view of the main part to explain phase delay of an upper plate cylinder in the rotational direction with respect to an upper blanket cylinder;

FIG. 5 is a front view showing a mounted state of blankets which are to be mounted on the circumferential surface of the upper plate cylinder and that of a lower plate cylinder;

FIG. 6 is a sectional view taken along the line VI-VI of FIG. 5;

FIG. 7 is an enlarged side view of an opposing portion of the upper blanket cylinder and a blanket cylinder when coating the obverse and reverse of a sheet;

FIG. 8 is a schematic side view showing a state in which the obverse and reverse of the sheet are coated; and

FIG. 9 is a schematic front view showing a state in which the obverse and reverse of the sheet are coated.

### DESCRIPTION OF THE PREFERRED EMBODIMENT

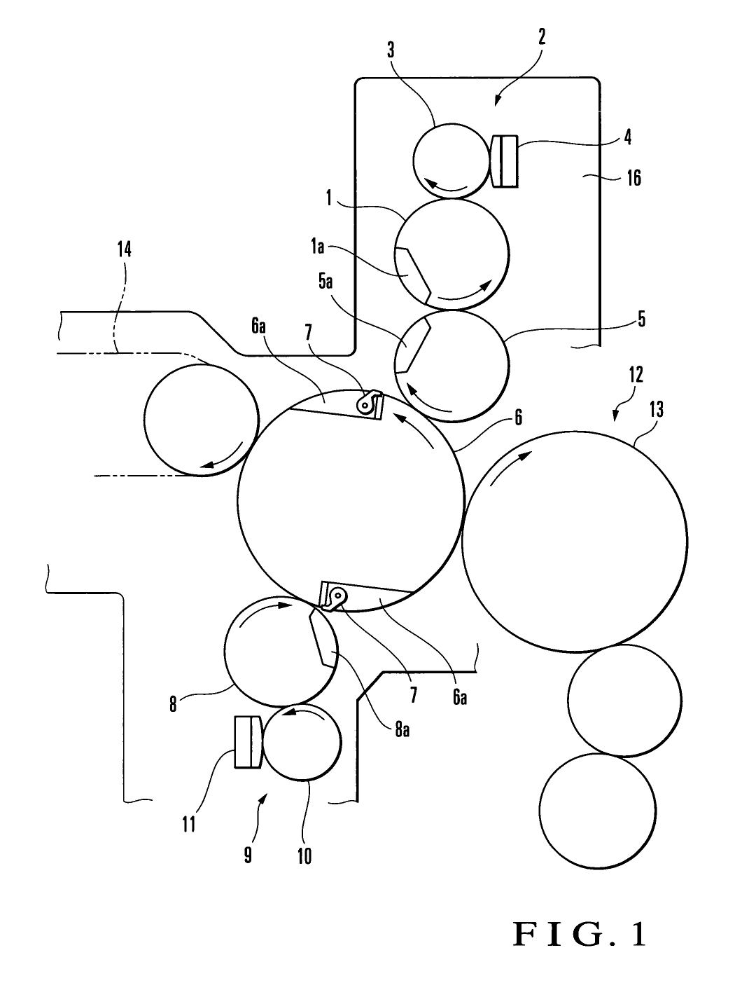

The embodiment of the present invention will be described with reference to the accompanying drawings. A case will be described with reference to FIGS. 1 to 9 in which a liquid transfer apparatus according to the present invention is applied to a coating unit in a printing press. This coating unit can subject one or two surfaces of a sheet to overall coating, or partial coating to coat only a specific portion. A case will be described in which the sheet is to be subjected to overall coating. The definition of overall coating is as described above.

The coating unit will be briefly described with reference to FIG. 1. An upper plate cylinder 1 serves as a varnish supply cylinder (liquid supply cylinder) and is provided with a notch la, extending in the axial direction, in part of its circumferential surface. A first varnish supply device 2 is a first liquid supply means for supplying varnish to the upper plate cylinder 1, and comprises an upper anilox roller 3 in contact with the upper plate cylinder 1 and a chamber coater 4 which supplies the varnish to the upper anilox roller 3. The first varnish supply device 2 and upper plate cylinder 1 constitute a first varnish feeding device (first liquid feeding means) which supplies the varnish to the upper plate cylinder 1.

An upper blanket cylinder 5 is a printing cylinder serving as a first transfer cylinder, and is in contact with the upper plate cylinder 1 and opposes a blanket cylinder 6 (to be described later). The upper blanket cylinder 5 is provided with a notch 5a, extending in the axial direction, in part of its circumferential surface. The blanket cylinder 6 is a printing cylinder serving as a transport cylinder. The blanket cylinder 6 is provided with a pair of notches 6a, extending in the axial direction, at positions that halve the circumferential surface of the blanket cylinder 6 in the circumferential direction. A gripper unit 7 (sheet holding means) which grips and holds the sheet is arranged in each notch 6a.

A lower plate cylinder 8 serves as a second transfer cylinder in contact with the blanket cylinder 6, and is provided with a notch 8a, extending in the axial direction, in part of its circumferential surface. A second varnish supply device 9 is a second liquid supply means for supplying the varnish to the lower plate cylinder 8, and comprises a lower anilox roller 10 in contact with the lower plate cylinder 8, and a chamber coater 11 which supplies the varnish to the lower anilox roller 10. The second varnish supply device 9 and lower plate cylinder 8 constitute a second varnish feeding device (second varnish feeding means) which supplies the varnish to the lower plate cylinder 8.

The upper blanket cylinder 5 opposes the blanket cylinder 6, downstream of an opposing position where an impression cylinder 13 of a printing unit 12 provided upstream of the coating unit opposes the blanket cylinder 6, in the downstream rotational direction of the blanket cylinder 6. The lower plate cylinder 8 opposes the blanket cylinder 6, upstream of an opposing position where the impression cylinder 13 of the printing unit 12 opposes the blanket cylinder 6, in the upstream rotational direction of the blanket cylinder 6.

The varnish supplied from the chamber coater 4 to the upper anilox roller 3 is transferred to the upper blanket cylinder 5 through the upper plate cylinder 1, so that the obverse of printed paper (sheet), passing through the opposing point (nip) where the upper blanket cylinder 5 opposes the blanket cylinder 6, is coated. As the sheet passes the opposing position of the upper blanket cylinder 5 and blanket cylinder 6, the reverse of the printed sheet is coated with the varnish, transferred from the lower plate cylinder 8 to the circumferential surface of the blanket cylinder 6, by the printing pressure of the upper blanket cylinder 5. The sheet with the coated reverse is gripping-changed to the gripper of a delivery chain 14 and conveyed to a sheet delivery device (not shown).

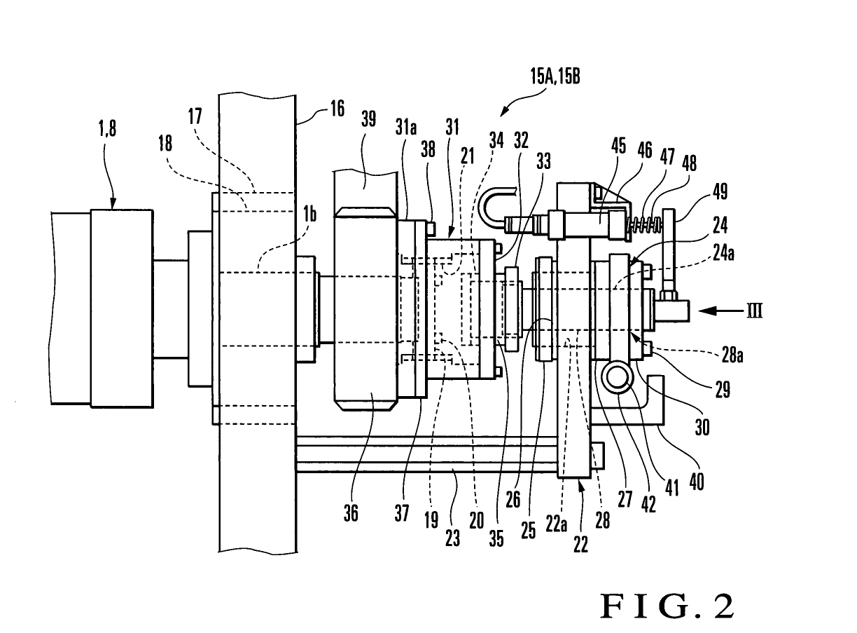

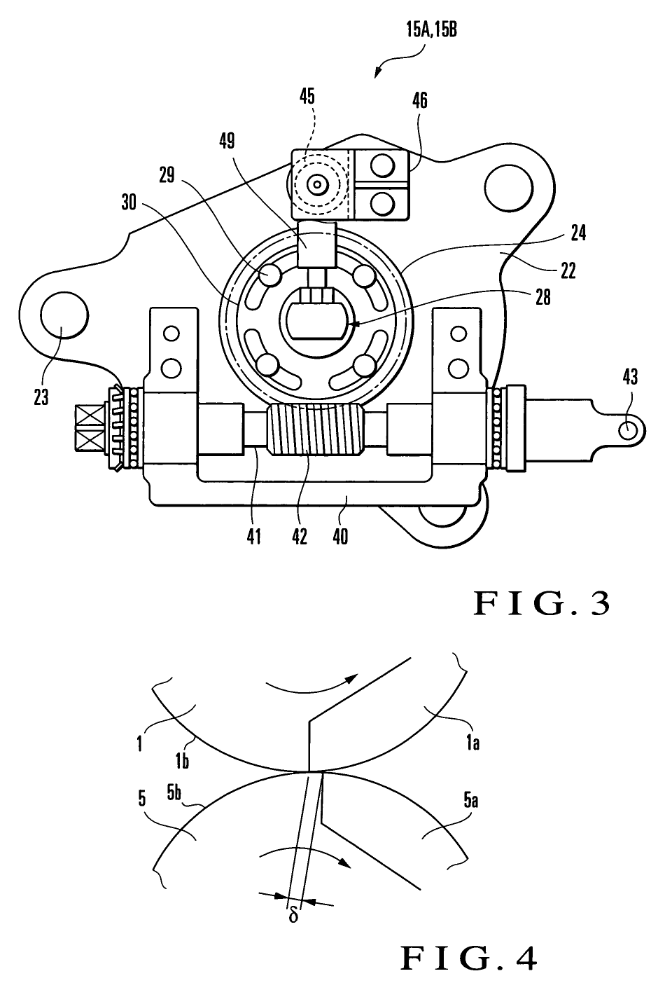

A first phase adjustment device (first phase adjusting means) 15A provided to the upper plate cylinder 1 and a second phase adjustment device (second phase adjusting means) 15B provided to the lower plate cylinder 8 will be described with reference to FIGS. 2 and 3. As the first and second phase adjustment devices 15A and 15B have the same structure, only the first phase adjustment device 15A will be described, and the second phase adjustment device 15B will be described where necessary.

Referring to FIG. 2, an end shaft 1b of the upper plate cylinder 1 is axially supported by an external metal member 17, axially supported by a frame 16 of the printing press, through an internal metal member 18. Bolts 20 fix an external gear 19 to the projecting end of the end shaft 1b projecting outside from the frame 16. The external gear 19 meshes with an internal gear 21 (to be described later).

Outside the frame 16, an almost triangular bracket 22 is attached to the frame 16 through a plurality of stays 23 to be parallel to the frame 16. A stepped worm wheel 24 is rotatably fitted in a bearing hole 22a of the bracket 22. A nut 25 threadably engaging with a threaded portion formed on the distal end of the worm wheel 24 presses a thrust bearing 26 (to be described later) against the bracket 22.

The thrust bearing 26 and a thrust bearing 27 are interposed on the two sides of the bracket 22 to sandwich it. A screw shaft 28 with a flange is inserted in a hole 24a formed in the inner peripheral portion of the worm wheel 24. A threaded plate 30 fixed to the worm wheel 24 with a bolt 29 threadably engages with the distal end of a threaded portion 28a of the screw shaft 28.

A coupling 31 has the internal gear 21 described above on its inner circumferential surface, and a disc 32 is threadably mounted on its one open end. One end of the screw shaft 28 described above is fitted in the inner hole of the disc 32. The flange of the screw shaft 28 and the nut 33 sandwich the disc 32. The flange of the screw shaft 28, the nut 33, and the disc 32 clamp thrust bearings 34 and 35. With this arrangement, the screw shaft 28 and coupling 31 are pivotal relative to each other while their movements in the axial directions are regulated.

A helical gear 36 is fixed to a flange 31a of the coupling 31 by a ring 37 and bolt 38, and meshes with a drive side helical gear 39. Rotation of the driving side is transmitted to the upper plate cylinder 1 through the helical gears 39 and 36, internal gear 21, and external gear 19. Since the external gear 19 and internal gear 21 slidably mesh with each other and the internal gear 21 has a large face width, even when the coupling 31 moves in the axial direction, the external gear 19 and internal gear 21 do not disengage from each other.

A bearing box 40 with a box-like shape as shown in FIG. 3 is fixed to the bracket 22 described above. A worm 42 meshing with the worm wheel 24 is axially mounted on a worm shaft 41 axially supported by the bearing box 40. The worm shaft 41 is connected to a motor (not shown) through a joint 43.

Another bracket 46 is fixed to the upper portion of the bracket 22. A linear displacement type potentiometer 45 is fixed to the bracket 46. The potentiometer 45 comprises a detection body 48 which is biased in the elongating direction by the spring force of a compression coil spring 47. A press body 49 is fixed to the distal end of the screw shaft 28. The upper end of the press body 49 is in contact with the detection body 48. As will be described later, when the screw shaft 28 moves in the axial direction upon phase adjustment of the upper plate cylinder 1, the press body 49 cooperates with the compression coil spring 47 to press the detection body 48. The potentiometer 45 detects the forward/backward moving amount of the detection body 48. The phase adjustment amount of the upper plate cylinder 1 is calculated from the forward/backward moving amount. A panel (not shown) displays the calculated phase adjustment amount.

In this arrangement, when the worm shaft 41 pivots to pivot the worm wheel 24, thus pivoting the screw shaft 28, the screw shaft 28 moves in the axial direction due to the screw function of the threaded portion 28a. The coupling 31 and helical gear 36 which are integral with the screw shaft 28 in the axial direction also move in the axial direction. The upper plate cylinder 1 slightly pivots in the circumferential direction due to the helical function of the helical gears 36 and 39, so that the phase of the upper plate cylinder 1 is adjusted with respect to the upper blanket cylinder 5. Thus, as shown in FIG. 4, the phase of the upper plate cylinder 1 is delayed from that of the upper blanket cylinder 5 by δ. More specifically, the rotation start of that effective impression area 1b of the upper plate cylinder 1, which is continuous to the notch 1a, is positioned upstream of a rotation start of an effective impression area 5b of the upper blanket cylinder 5, which is continuous to the notch 5a, by δ in the rotational direction of the upper plate cylinder 1. Similarly, when operating the second phase adjustment device 15B, the lower plate cylinder 8 slightly pivots in the circumferential direction to adjust its phase with respect to the blanket cylinder 6.

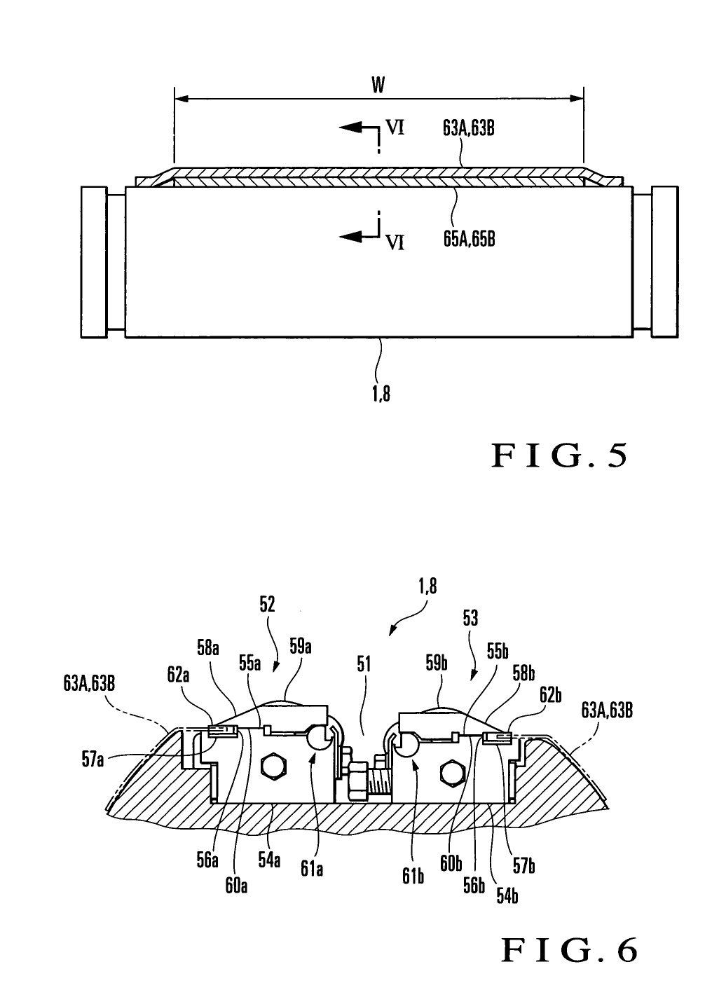

The mounting structures for blankets 63A and 63B which are mounted on the circumferential surface of the upper plate cylinder 1 and on that of the lower plate cylinder 8 will be described with reference to FIGS. 5 and 6. As the mounting structure for the upper plate cylinder 1 and that for the lower plate cylinder 8 are identical, only the mounting structure for the varnish supply cylinder blanket (blanket for a liquid supply cylinder) 63A and a varnish supply cylinder sheet member (sheet member for a liquid supply cylinder) 65A which are to be mounted on the upper plate cylinder 1 will be described, and the mounting structure for the second transfer cylinder blanket (blanket for a second transfer cylinder) 63B and a second transfer cylinder sheet member (sheet member for a second transfer cylinder) 65B which are to be mounted on the lower plate cylinder 8 will be described where necessary.

As shown in FIG. 6, the upper plate cylinder 1 is provided with a notch 51, extending throughout the entire length of the cylinder, in its circumferential surface. A leading edge plate clamp (plate member holding device) 52 and trailing edge plate clamp (plate member holding device) 53 extend in the notch 51 in the axial direction of the cylinder 1 to be parallel to each other. The leading edge plate clamp 52 and trailing edge plate clamp 53 are respectively provided with bottom clamping rails 54a and 54b extending in the axial direction of the cylinder 1. The bottom clamping rails 54a and 54b are respectively provided with gripping surfaces 55a and 55b and mouthpiece insertion grooves 56a and 56b on their upper surfaces. The mouthpiece insertion grooves 56a and 56b continue to the gripping surfaces 55a and 55b, respectively. The bottom surfaces of the mouthpiece insertion grooves 56a and 56b are parallel to the gripping surfaces 55a and 55b, respectively, and extend in the axial direction of the cylinder 1. Spacers 57a and 57b are fixed to the bottom surfaces of the mouthpiece insertion grooves 56a and 56, respectively.

Bolts 59a and 59b screwed into the upper portions of the bottom clamping rails 54a and 54b swingably support gripper boards 58a and 58b, respectively. The gripper boards 58a and 58b are respectively provided with gripping surfaces 60a and 60b which oppose the gripping surfaces 55a and 55b of the bottom clamping rails 54a and 54b, respectively. The distal ends of the gripping surfaces 60a and 60b cover the mouthpiece insertion grooves 56a and 56b, respectively. Round rod-like cams 61a and 61b are in contact with the rear ends of the gripper boards 58a and 58b, respectively. When the cams 61a and 61b are pivoted, the gripper boards 58a and 58b swing about the bolts 59a and 59b as swing centers, respectively.

A case in which the varnish supply cylinder blanket 63A is to be mounted on the upper plate cylinder 1 (or a case in which the second transfer cylinder blanket 63B is to be mounted on the lower plate cylinder 8) will be described. A mouthpiece 62a attached to one end of the varnish supply cylinder blanket 63A (or second transfer cylinder blanket 63B) is inserted in the mouthpiece insertion groove 56a of the bottom clamping rail 54a. The cam 61a is pivoted so that the distal end of the gripper board 58a covers the mouthpiece insertion groove 56a. Thus, the distal end of the gripper board 58a urges the mouthpiece 62a to fix it in the mouthpiece insertion groove 56a.

The varnish supply cylinder blanket 63A (or second transfer cylinder blanket 63B) is wound around the circumferential surface of the upper plate cylinder 1 (or lower plate cylinder 8), and a mouthpiece 62b attached to the other end of the varnish supply cylinder blanket 63A (or second transfer cylinder blanket 63B) is inserted in the mouthpiece insertion groove 56b of the bottom clamping rail 54b. The cam 61b is pivoted so that the distal end of the gripper board 58b covers the mouthpiece insertion groove 56b. Thus, the distal end of the gripper board 58b urges the mouthpiece 62b to fix it in the mouthpiece insertion groove 56b.

When the bottom clamping rail 54b slides toward the center of the notch 51, that is, in the direction to tighten the varnish supply cylinder blanket 63A (or second transfer cylinder blanket 63B) to be close to the bottom clamping rail 54a, the varnish supply cylinder blanket 63A (or second transfer cylinder blanket 63B) is tightened to come into tight contact with the circumferential surface of the cylinder 1.

Referring to FIG. 5, the varnish supply cylinder sheet member 65A is interposed between the varnish supply cylinder blanket 63A and the circumferential surface of the upper plate cylinder 1, and is a so-called blanket underlying member. The varnish with the same shape as the outer shape of the varnish supply cylinder sheet member 65A is transferred to the obverse of the sheet, being conveyed by the blanket cylinder 6, through the upper blanket cylinder 5. More specifically, the varnish with the same width as a length W of the varnish supply cylinder sheet member 65A in the widthwise direction is transferred to the obverse of the sheet, and the varnish with the same length as the circumferential length of the varnish supply cylinder sheet member 65A is transferred to the obverse of the sheet.

The second transfer cylinder sheet member 65B is interposed between the second transfer cylinder blanket 63B and the circumferential surface of the lower plate cylinder 8, and is a so-called blanket underlying member. The varnish with the same shape as the outer shape of the second transfer cylinder sheet member 65B is transferred to the reverse of the sheet, being conveyed by the blanket cylinder 6, through the blanket cylinder 6. More specifically, the varnish with the same width as a length W of the second transfer cylinder sheet member 65B in the widthwise direction is transferred to the reverse of the sheet, and the varnish with the same length as the circumferential length of the second transfer cylinder sheet member 65B is transferred to the reverse of the sheet.

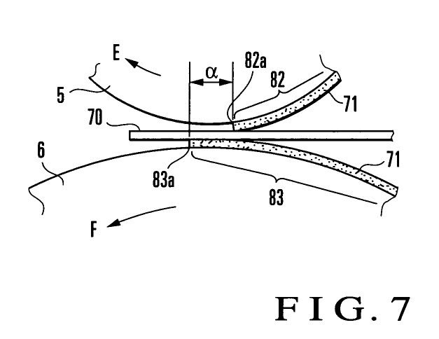

According to this embodiment, as shown in FIG. 4, the first phase adjustment device 15A adjusts the phase of the upper plate cylinder 1 to be delayed from the phase of the upper blanket cylinder 5 by δ, and the second phase adjustment device 15B adjusts the phase of the lower plate cylinder 8. After the cylinder phases are adjusted in this manner, the first and second varnish feeding devices described above supply the varnish to the upper blanket cylinder 5 and blanket cylinder 6, respectively. Thus, as shown in FIG. 7, an edge 82a of that region 82 of the upper blanket cylinder 5, downstream in the rotational direction (on the side in a direction E), where varnish 71 is supplied to the upper blanket cylinder 5 is positioned more upstream, by a length a in the upstream rotational direction of the upper blanket cylinder 5, of an edge 83a of a region 83 of the blanket cylinder 6, downstream in the rotational direction (on the side in a direction F), where the varnish 71 is supplied to the blanket cylinder 6.

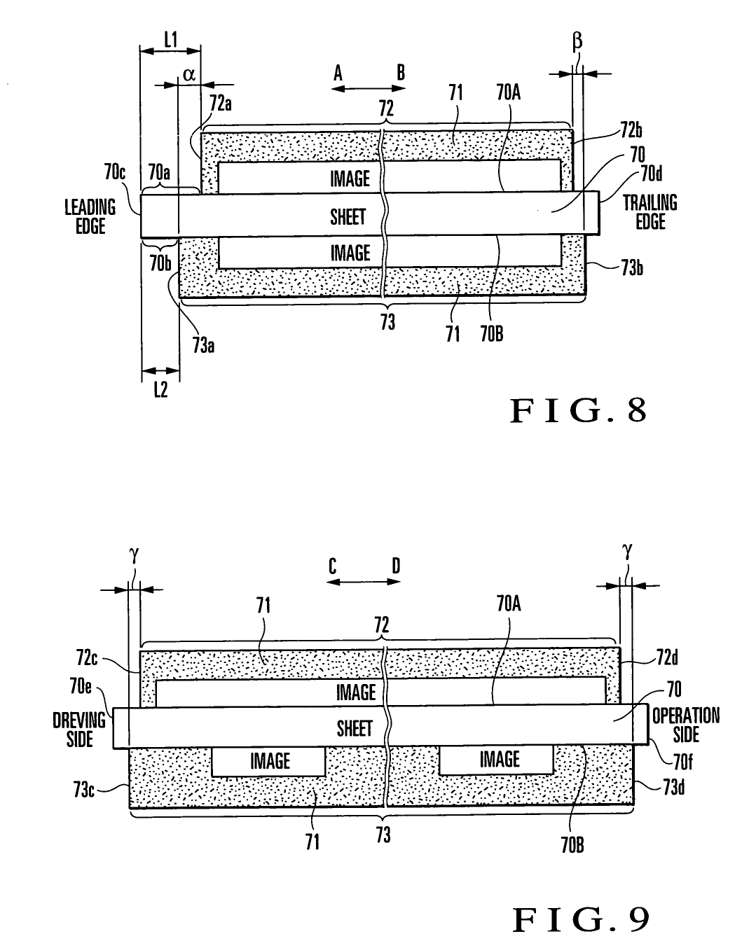

In the sheet 70 that has passed between the upper blanket cylinder 5 and blanket cylinder 6, as shown in FIG. 8, a leading (downstream in the sheet convey direction or in the direction of an arrow A) margin 70a of an obverse 70A of the sheet 70 which is not coated with the varnish 71 becomes larger by a length a than a leading margin 70b of a reverse 70B of the sheet 70 which is not coated with the varnish 71. In other words, a leading edge 72a of a coating region 72 of the obverse 70A of the sheet 70 is positioned on the trailing side (upstream in the sheet convey direction or in the direction of an arrow B) of a leading edge 73a of a coating region 73 of the reverse 70B of the sheet 70 by the length α.

The adjustment ranges of the first and second phase adjustment devices 15A and 15B are set such that a minimum value L1min of the length of the leading margin 70a of the obverse 70A of the sheet 70 which is adjusted by the first phase adjustment device 15A becomes lager than a maximum value L2max of the length of the leading margin 70b of the reverse 70B of the sheet 70 which is adjusted by the second phase adjustment device 15B. Thus, no matter how the first and second phase adjustment devices 15A and 15B may be adjusted, the length of the leading margin 70a of the obverse 70A of the sheet 70 does not become smaller than the length of the leading margin 70b of the reverse 70B. Therefore, the conventional problem does not occur, as will be described later.

The lengths of the leading margins 70a and 70b refer to the lengths from a leading edge 70c of the sheet 70 to leading edges 72a and 73a of the coating regions (liquid transfer regions) 72 and 73, respectively, in the sheet convey direction. The lengths of the trailing margins refer to the lengths from a trailing edge 70d of the sheet 70 to trailing edges 72b and 73b of the coating regions (liquid transfer regions) 72 and 73, respectively, in the sheet convey direction. The left and right margin lengths refer to the lengths from left and right trailing edges 70e and 70f of the sheet 70 to left and right trailing edges 72c and 72d and left and right trailing edges 73c and 73d of the coating regions (liquid transfer regions) 72 and 73, respectively, in the direction of sheet width.

According to this embodiment, the length of the varnish supply cylinder sheet member 65A in the circumferential direction (the directions of the arrows A and B) is smaller than the length of the second transfer cylinder sheet member 65B in the circumferential direction (the directions of the arrows A and B), so that the trailing edge 72b of the coating region 72 of the obverse 70A of the sheet 70 is located closer to the leading side by a length β than the trailing edge 73b of the coating region 73 of the reverse 70B of the sheet 70. The circumferential direction of the varnish supply cylinder sheet member 65A refers to the direction that corresponds to the circumferential direction of the upper plate cylinder 1 when the varnish supply cylinder sheet member 65A is mounted on the upper plate cylinder 1. Similarly, the circumferential direction of the second transfer cylinder sheet member 65B refers to the direction that corresponds to the circumferential direction of the lower plate cylinder 8 when the second transfer cylinder sheet member 65B is mounted on the lower plate cylinder 8.

According to the present invention, as shown in FIG. 9, the length of the varnish supply cylinder sheet member 65A in the widthwise direction (the direction perpendicular to the circumferential direction) is smaller than that of the second transfer cylinder sheet member 65B in the widthwise direction (the direction perpendicular to the circumferential direction) such that the left and right (in the widthwise direction or directions of arrows C and D) edges 72c and 72d of the coating region 72 of the obverse 70A of the sheet 70 are located within the sheet 70 to be inside the left and right (in the widthwise direction or the directions of arrows C and D) trailing edges 73c and 73d of the coating region 73 of the reverse 70B of the sheet 70 each by a length γ than. The widthwise direction of the varnish supply cylinder sheet member 65A refers to the direction that corresponds to the axial direction of the upper plate cylinder 1 when the varnish supply cylinder sheet member 65A is mounted on the upper plate cylinder 1. Similarly, the widthwise direction of the second transfer cylinder sheet member 65B refers to the direction that corresponds to the axial direction of the lower plate cylinder 8 when the second transfer cylinder sheet member 65B is mounted on the lower plate cylinder 8.

Immediately after the sheet 70 passes through the nip between the upper blanket cylinder 5 and blanket cylinder 6, the tackiness of the varnish on the obverse 70A of the sheet 70 exerts a force to stick the sheet 70 to the upper blanket cylinder 5. According to this embodiment, however, as shown in FIG. 8, when the leading edge 70c of the sheet 70 passes between the blanket cylinder 6 and upper blanket cylinder 5, the varnish is applied to the reverse 70B of the sheet 70, prior to the obverse 70A of the sheet 70, starting from the portion closer to the leading edge 70c. As coating of the reverse 70B is started prior to the obverse 70A of the sheet 70 in this manner, the tackiness of the varnish on the reverse 70B of the sheet 70 serves to prevent the leading edge of the sheet 70 from separating from the blanket cylinder 6 to undesirably stick to the circumferential surface of the upper blanket cylinder 5. As a result, the blanket cylinder 6 suppresses varnish nonuniformities in the coating region 73 of the reverse 70B of the sheet 70, thus improving the coating quality.

On the trailing edge side of the sheet 70, the varnish is applied to the reverse 70B of the sheet 70 even after it is applied to the obverse 70A of the sheet 70. Thus, after the trailing edge 70d of the sheet 70 passes between the blanket cylinder 6 and upper blanket cylinder 5, the trailing edge of the obverse 70A of the sheet 70 does not stick to the circumferential surface of the upper blanket cylinder 5. Hence, the blanket cylinder 6 suppresses varnish nonuniformities in the coating region 73 of the reverse 70B of the sheet 70, thus improving the coating quality.

As the sheet 70 passes between the blanket cylinder 6 and upper blanket cylinder 5, the sheet 70 is coated such that the left and right edges 72c and 72d of the coating region 72 of the obverse 70A of the sheet 70 is located within the sheet 70 to be inside the left and right edges 73c and 73d of the coating region 73 of the reverse 70B of the sheet 70 by the length γ. As the coating region 73 of the reverse 70B of the sheet 70 is larger than the coating region 72 of the obverse 70A of the sheet 70 in this manner, after the sheet 70 passes between the blanket cylinder 6 and upper blanket cylinder 5, the left and right edges of the obverse 70A of the sheet 70 do not stick to the circumferential surface of the upper blanket cylinder 5. Thus, the blanket cylinder 6 suppresses varnish nonuniformities in the coating region 73 of the reverse 70B of the sheet 70, thus improving the coating quality.

According to this embodiment, varnish (coating liquid) is employed as the liquid to be transferred. The present invention can also be applied to ink with a comparatively high viscosity. Although the sheet to which the liquid is to be transferred is exemplified by paper sheet, the transfer target can be any other sheet. For example, a non-rigid sheet such as a synthetic resin film or vinyl film can be employed as the transfer target sheet.

In this embodiment, a phase signifies a position on the cylinder in the rotational direction and is expressed by an angle with respect to the reference position of the cylinder.

What is claimed is:

1. A liquid transfer method comprising the steps of:
conveying a sheet by holding the sheet by a transport cylinder; and
transferring a liquid to one surface of the sheet by a transfer cylinder opposing the transport cylinder and transferring the liquid to the other surface of the sheet by the transport cylinder,
wherein the step of transferring comprises the step of positioning an edge of a region on one surface of the sheet, downstream in a sheet convey direction, where the liquid is to be transferred, upstream in the sheet convey direction of an edge of a region on the other surface of the sheet, downstream in the sheet convey direction, where the liquid is to be transferred.

2. A method according to claim 1, wherein the step of transferring comprises the step of coating an entire region of each of the two surfaces of the sheet excluding a margin, by using a coating liquid as the liquid.

3. A method according to claim 1, wherein the step of transferring comprises the step of positioning an edge of the region on one surface of the sheet, upstream in the sheet convey direction, where the liquid is to be transferred, to be downstream in the sheet convey direction of an edge of the region on the other surface of the sheet, upstream in the sheet convey direction, where the liquid is to be transferred.

4. A method according to claim 1, wherein the step of transferring further comprises the step of positioning an edge of the region on one surface of the sheet, in a direction perpendicular to the sheet convey direction, where the liquid is to be transferred, to be inside an edge of the region on the other surface of the sheet, in the direction perpendicular to the sheet convey direction, where the liquid is to be transferred.

5. A method according to claim 1, further comprising the step of supplying the liquid to each of the first transfer cylinder and the transport cylinder such that an edge of a region of the first transfer cylinder, downstream in a rotational direction, where the liquid is to be transferred to the first transfer cylinder is located upstream in the rotational direction of the first transfer cylinder, of an edge of a region of the transport cylinder, downstream in the rotational direction, where the liquid is to be transferred to the transport cylinder.

6. A liquid transfer apparatus comprising:
a first transfer cylinder which transfers a liquid to one surface of a sheet; and
a transport cylinder which opposes said first transfer cylinder, holds and conveys the sheet, and transfers the liquid to the other surface of the sheet,
wherein said first transfer cylinder and said transport cylinder transfer the liquid such that an edge of a region on one surface of the sheet, downstream in a sheet convey direction, where the liquid is to be transferred is located upstream in the sheet convey direction of an edge of a region on the other surface of the sheet, downstream in the sheet convey direction, where the liquid is to be transferred.

7. An apparatus according to claim 6,
wherein the liquid to be transferred to the two surfaces of the sheet comprises a coating liquid, and
said first transfer cylinder and said transport cylinder transfer the liquid to an entire region of each of the two surfaces of the sheet excluding a margin.

8. An apparatus according to claim 6,
wherein said first transfer cylinder and said transport cylinder transfer the liquid such that an edge of the region on one surface of the sheet, upstream in the sheet convey direction, where the liquid is to be transferred is located downstream in the sheet convey direction of an edge of the region on the other surface of the sheet, upstream in the sheet convey direction, where the liquid is to be transferred.

9. An apparatus according to claim 6, wherein said first transfer cylinder and said transport cylinder transfer the liquid such that an edge of the region on one surface of the sheet, in a direction perpendicular to the sheet convey direction, where the liquid is to be transferred is located to be inside an edge of the region on the other surface of the sheet, in the direction perpendicular to the sheet convey direction, where the liquid is to be transferred.

10. An apparatus according to claim 6, further comprising a liquid supply cylinder which comes into contact with said first transfer cylinder to supply the liquid thereto,
wherein a phase of said liquid supply cylinder is delayed from that of said first transfer cylinder.

11. An apparatus according to claim 10, further comprising
first phase adjusting means for adjusting the phase of said liquid supply cylinder with respect to said first transfer cylinder,
a second transfer cylinder which comes into contact with said transport cylinder to transfer the liquid thereto, and
second phase adjusting means for adjusting a phase of said second transfer cylinder with respect to said transport cylinder,
wherein said first phase adjusting means and said second phase adjusting means adjust the phases such that a minimum value of a length of a margin of one surface of the sheet downstream in the convey direction is larger than the maximum value of a length of a margin of the other surface of the sheet downstream in the convey direction.

12. An apparatus according to claim 6, further comprising
first liquid feeding means for supplying the liquid to said first transfer cylinder, and
second liquid feeding means for supplying the liquid to said transport cylinder,
wherein said first liquid feeding means and said second liquid feeding means respectively supply the liquid to said first transfer cylinder and said transport cylinder such that an edge of a region of said first transfer cylinder, downstream in a rotational direction, where the liquid is to be transferred to said first transfer cylinder is located upstream in the rotational direction of said first transfer cylinder, of an edge of a region of said transport cylinder, downstream in the rotational direction, where the liquid is to be transferred to said transport cylinder.

13. An apparatus according to claim 6,
wherein said liquid supply cylinder comprises
a blanket for said liquid supply cylinder to be mounted on a circumferential surface of said liquid supply cylinder, and
a sheet member for said liquid supply cylinder to be sandwiched between said blanket for said liquid supply cylinder and said circumferential surface of said liquid supply cylinder,
said second transfer cylinder comprises
a blanket for said second transfer cylinder to be mounted on a circumferential surface of said second transfer cylinder and
a sheet member for said second transfer cylinder to be sandwiched between said blanket for said second transfer cylinder and said circumferential surface of said second transfer cylinder, and
a length of said sheet member for said liquid supply cylinder in a circumferential direction of said liquid supply cylinder is smaller than that of said sheet member for said second transfer cylinder in a circumferential direction of said second transfer cylinder.

14. An apparatus according to claim 9,
wherein said liquid supply cylinder comprises
a blanket for said liquid supply cylinder to be mounted on a circumferential surface of said liquid supply cylinder, and
a sheet member for said liquid supply cylinder to be sandwiched between said blanket for said liquid supply cylinder and said circumferential surface of said liquid supply cylinder,
said second transfer cylinder comprises
a blanket for said second transfer cylinder to be mounted on a circumferential surface of said second transfer cylinder and
a sheet member for said second transfer cylinder to be sandwiched between said blanket for said second transfer cylinder and said circumferential surface of said second transfer cylinder, and
a length of said sheet member for said liquid supply cylinder in an axial direction of said liquid supply cylinder is smaller than that of said sheet member for said second transfer cylinder in an axial direction of said second transfer cylinder.
